(19) United States
(12) Patent Application Publication
(10) Pub. No.: US 2009/0213428 A1
(43) Pub. Date: Aug. 27, 2009

(54) AUTOMATED LAYOUT

(76) Inventor: John H. Klippenstein, Roberts Creek (CA)

Correspondence Address: David A. Novais;Patent Legal Staff, Eastman Kodak Company, 343 State Street, Rochester, NY, 14650-2201, US

(21) Appl. No.: 12/038,013

(22) Filed: Feb. 27, 2008

(51) Int. Cl. H04N 1/387

(52) U.S. Cl. 358/1.18

(57) ABSTRACT

A system and method for arranging a plurality of items on a sheet is described. Build trees, based on an ordered sequence of a plurality of items, with nodes representing the items and/or meta-items derived from pairings of items and/or other meta-items, are formed. A build tree is traversed to identify a candidate layout. Candidate layouts are evaluated to determine whether they fit the sheet and then to identify candidate layouts that optimize printing-related activities. The ordered sequence is designed to reduce the quantity of sheets required to produce the desired quantity of items.

### CROSS REFERENCE TO RELATED APPLICATIONS

Reference is made to commonly-assigned copending U.S. patent application Ser. No. 11/849,534, filed Sep. 4, 2007, entitled SIMULTANEOUS PRINTING OF PAGES FROM MULTIPLE JOBS, by Geoffrey Huenemann, the disclosure of which is incorporated herein.

### FIELD OF THE INVENTION

The present invention pertains to producing layouts from a collection of items and in particular to methods and systems for automatically producing the layouts.

### BACKGROUND OF THE INVENTION

In the printing industry, it is common for a printer to gather a collection of items to be printed and print them together as a layout on a printing sheet. The printing sheet is then cut to yield the desired printed items and the printed items are then finished by collating, binding, and other post-printing activities. A printing item includes information specifying printable content and dimensions. Exemplary printing items include document pages, business cards, and packaging labels. Printing items and printing sheets are often rectangular in shape and can exist in a wide variety of dimensions. In some circumstances, such as in package printing, items and sheets can be of different shapes. Printing items may also include or be associated with other information, such as information specifying printing intent (e.g. desired quantity, type of printing sheet paper, number and types of ink).

A printer will often have a number of printing presses, each of which can print on a variety of printing sheet sizes. Print jobs, specifying one or more print items, can be received at different times. “Just in time” printing, as with other manufacturing industries, is popular because it can optimize many of the manufacturing plant's resources (e.g. equipment, staff, inventory). As an example, a print shop may collect print jobs and print them based on their due date and the availability of specific printing equipment.

As a particular example, at a given point in time, a printer may have a collection of a dozen print items and an available printing press having six supported printing sheet sizes. Thus, the printer's goal may be to determine which printing sheet to use, determine which items to arrange in a layout for the printing sheet, and determine how many copies of the printing sheet to produce to satisfy the collective requirements of the associated print jobs. Further, the printing sheet layout may also be chosen to optimize one or more printing-related processes (e.g. press operation and finishing).

Prior to the present invention, many printers have performed this layout task manually. This approach suffers from being relatively slow and/or requiring significant skill in identifying layouts that optimize printing-related activities.

Various automatic methods for determining a layout that optimizes printing sheet utilization are known in the art. Some methods are directed to searching a large discrete space of potential layouts for an optimized layout. An example of this is U.S. Pat. No. 6,934,052 (Venable), which teaches a simulated annealing algorithm based on a cost function derived for a layout.

Some methods are directed towards placing constraints on the number of layout combinations to be evaluated. An example of this is U.S. Patent Application Publication No. 2005/0012961 (Holt), which teaches limiting the ratio of print items in a layout to a selection of ratios based on the desired quantity of each print item. The reduced set of layout combinations involving these ratios are then searched for optimized layouts. U.S. Patent Application Publication No. 2005/0012961 also teaches a further reduction in combinations to be evaluated by establishing further constraints (e.g. preferred item position, item rotation, and sheet cut orientation).

Another example of reducing combinations is found in commonly-assigned copending U.S. patent application Ser. No. 11/849,534 (Huenemann), which teaches iteratively selecting items for placement selected from a collection of items based on available space, item characteristics and successively relaxed fit tolerances.

Prior art by Andreas Fritsch et al. is described in the paper “Cutting Stock by Iterated Matching,” published in Operations Research Proceedings, Selected Papers of the Int. Conf. on OR 94, 1995, pp. 1-13. Fritsch et al. describes the use of shape functions and binary trees based on those shape functions as useful constructs for organizing and evaluating layout combinations.

While the prior art methods, exemplified above, are relatively effective at finding optimized solutions, each suffers from one or more limitations including: processing a fixed collection of items, unnecessarily restricting the space of potential solutions evaluated, and being computationally intensive.

Therefore, a need exists to identify an optimized layout for a sheet from a collection of items where determining the layout is time-limited while still being able to effectively search a wide range of possible layout combinations determined by a subset of items from the collection. Further, a need exists to evaluate a layout based on both sheet fit and other printing-related activities.

### SUMMARY OF THE INVENTION

The present invention provides a system and method for arranging a plurality of items on a sheet. According to one embodiment of the invention, the sheet is a printing sheet and the plurality of items comprise a plurality of printing content items defined by at least one print job. A desired printing quantity is specified for each item. The present invention provides a time-limited, iterative process for identifying an efficient layout that reduces the number of sheets required to produce the desired quantity of the plurality of items.

According to one aspect of the invention, a plurality of items is selected for arrangement on a sheet of specific dimensions. The items can be selected according to some criteria designed to improve efficiency.

According to another aspect of the invention, an ordered sequence of items is determined based on the selected items. A first sequence of items is formed from the selected items. Additional copies of some items are appended to the sequence of items in order to reduce the number of sheets required to produce the desired quantity of each item. A copy of a quantity-governing item is added while the aggregate area of the ordered sequence of items is less than the sheet area.

According to another aspect of the invention, a first sub-sequence of the ordered sequence of items is selected to build a first candidate layout as a starting point. The method of building is based on deterministic criteria designed to build a relatively efficient layout that fits the sheet.

According to another aspect of the invention, an iterative process is performed to produce additional candidate layouts that fit the sheet for a same-sized or larger sub-sequence. According to one embodiment of the invention, the iterative process includes three time-limited, serialized sub-processes, including:
A first process designed to find the largest sub-sequence which can produce a candidate layout that fits the sheet where the candidate layout is built using deterministic criteria.
A second process designed to find the largest sub-sequence which can produce at least one candidate layout that fits the sheet where candidate layouts are built using randomized criteria and by searching for closer fitting candidate layouts in the neighborhood of existing candidate layouts that do not fit.
A third process designed to find additional candidate layouts for the largest sub-sequence identified in the first two processes wherein candidate layouts are built using randomized criteria and by searching for lower cost candidate layouts in the neighborhood of existing candidate layouts having higher printing-related costs.

According to another aspect of the invention, producing a candidate layout can comprise identifying a build tree including a plurality of nodes, each node representing an item or a meta-item representing a set of arrangements of a pair of nodes. A candidate layout is created by traversing the build tree to allocate a portion of the sheet to each meta-item or item.

According to another aspect of the invention, a preferred candidate layout is selected from amongst the set of candidate layouts identified earlier. These and other aspects of the present invention are illustrated in the detailed description of the invention.

### BRIEF DESCRIPTION OF THE DRAWINGS

FIG. 1 is a diagram illustrating an exemplary meta-item according to the present invention.

FIG. 2 is a diagram illustrating an exemplary shape function according to the present invention.

FIG. 3 is a diagram illustrating an exemplary build tree according to the present invention.

FIG. 4 is a flow chart diagram illustrating an exemplary method for identifying a layout for a list of items on a sheet according to the present invention.

FIG. 5 is a flow chart diagram illustrating an exemplary method for iteratively finding candidate layouts that optimize sheet utilization according to the present invention.

FIG. 6 is a flow chart diagram illustrating an exemplary method for iteratively finding candidate layouts that optimize printing-related activities according to the present invention.

FIG. 7A is a diagram illustrating a build tree for a candidate layout identified according to the present invention.

FIGS. 7B-7D are diagrams illustrating exemplary SFs for nodes of the build tree of FIG. 7A according to the present invention.

FIG. 7E is a diagram illustrating redundant meta-items removed from the SF depicted in FIG. 7D according to the present invention.

FIG. 7F is a diagram illustrating an exemplary candidate layout derived for the build tree of FIG. 7A according to the present invention.

FIG. 8A is a diagram illustrating an exemplary build tree identified by searching for neighboring candidate layouts.

FIG. 8B is a diagram illustrating an exemplary candidate layout derived for the build tree of FIG. 8A.

FIG. 9 is a diagram illustrating an exemplary candidate layout that is more costly to process than candidate layout of FIG. 7F.

### DETAILED DESCRIPTION OF THE INVENTION

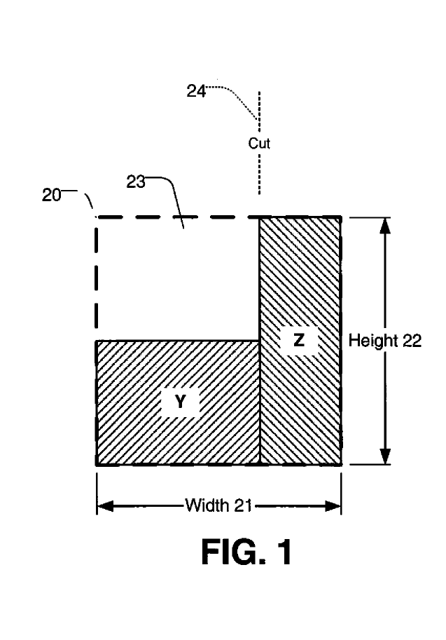

FIG. 1 is a diagram illustrating an exemplary meta-item 20 according to the present invention. Meta-item 20 represents one possible arrangement of constituent items Y and Z. As depicted meta-item 20 and items Y and Z are rectangles but they need not be rectangles. They could be polygons or other geometric shapes. In practice, rectangles are computationally efficient so rectangular representations for items Y and Z and meta-items 20 can correspond to bounding boxes for the associated objects.

As illustrated, meta-item 20 can include information about: dimensions, width 21 and height 22; overall area; wasted area 23; and cut 24, which can be made to a sheet comprising meta-item 20 to yield items Y and Z. Items Y and Z can also include information about dimensions. For example, assume item Y has dimensions 4×3 and item Z has dimensions 2×6.

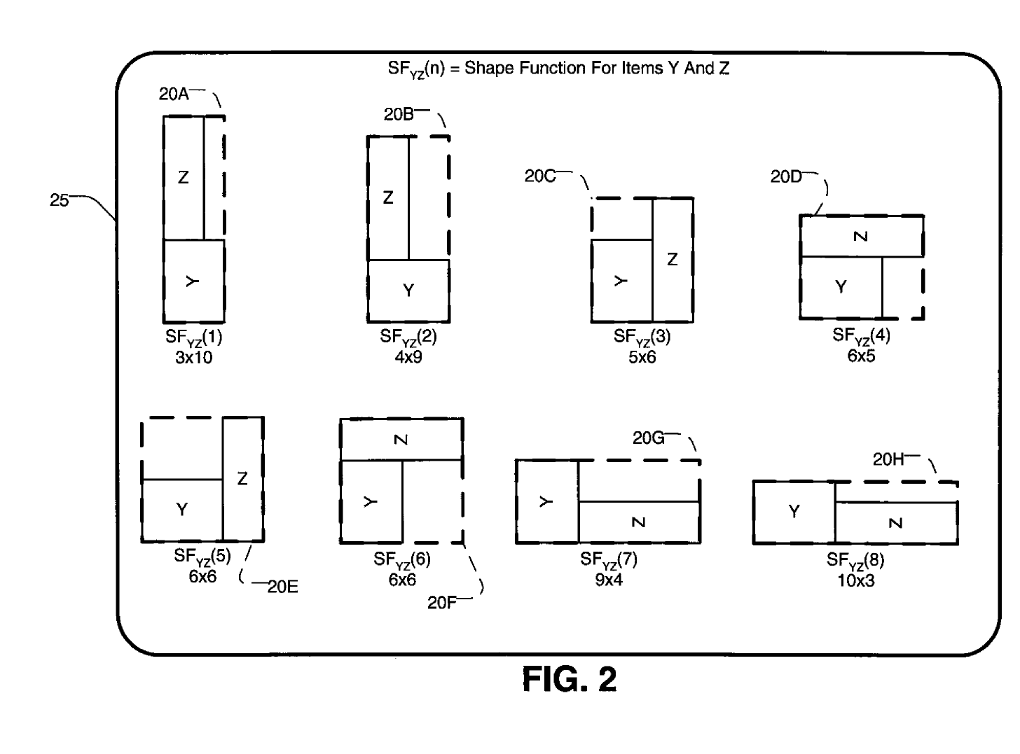

FIG. 2 is a diagram illustrating an exemplary shape function 25 according to the present invention. Shape function (SF) 25 is a discrete function of two objects (Y and Z of FIG. 1) wherein each discrete value of SF 25 corresponds to a specific meta-item 20 for the pair of basis objects. SF 25, as depicted, has eight discrete values: SF_{YZ}(1) . . . SF_{YZ}(8), corresponding to meta-items 20A-20H. Meta-items 20A-20H, in turn, represent combinations of adjoining arrangements of items Y and Z with varying 90° rotations and adjoining directions (i.e. vertical and horizontal). The meta-item boundary is illustrated with a dashed line and dimensions annotated. For clarity, other information, such as cutting information, is not shown.

In one embodiment, the range of SF values is restricted. In particular, the range can be restricted based on characteristics of the meta-items. As one example, the range can be restricted to exclude certain meta-items that share a dimension with another meta-item. For example, a taller meta-item, having a width in common with a shorter meta-item, is excluded to reduce waste.

As another example, the range of SF values can be restricted to only exclude taller meta-items with the same cut attributes. For example, meta-item 20D and 20F have the same dimensions but the first cut for meta-item 20D is vertical whereas the first cut for meta-item 20F is horizontal. Clearly, other rules for controlling the range of SF values can be established. As an example, if it was needed, additional values for SF 25 could be derived from SF_{XY}(1), namely with item Z having alternate horizontal positions within meta-item 20A.

In some embodiments, SF values can be ordered to optimize searching. Ordering on the basis of dimensions, overall area, waste or other attributes can be used. In the example of FIG. 2, ordering occurred first on the basis of width and then height.

As will be seen below, items, meta-items, and SFs are the basic informational building blocks incorporated by the present invention. An example layout scenario is used to facilitate further description of the various embodiments and aspects of the present invention.

First, assume that a printing shop has a backlog of pending print jobs. Each print job specifies one or more items to be printed and a desired quantity for each item. Table 1 depicts an exemplary list of items to be printed, along with their dimensions, calculated area and desired quantity.

TABLE 1
Items To Print

| | Ref. | | | | Desired |
|---|---|---|---|---|---|
| Item Id | Numeral | Width | Height | Area | Quantity |
| A | 1 | 50 | 50 | 2500 | 500 |
| B | 2 | 25 | 75 | 1875 | 500 |
| C | 3 | 25 | 25 | 625 | 1000 |
| D | 4 | 25 | 50 | 1250 | 500 |
| F | N/A | 75 | 75 | 5625 | 10 |
| E | 5 | 10 | 25 | 250 | 800 |

In practice, the list of items may be considerably longer than this. The list is preferably orderable according to some criteria. As an example, the items can be ordered by due date or profit margin. Next, a printing sheet size is determined. This may be done, for example, manually by a print operator or automatically by a system that performs scheduling of printing shop resources. For our example, assume a sheet size of dimensions 75×100 (width×height) has been selected.

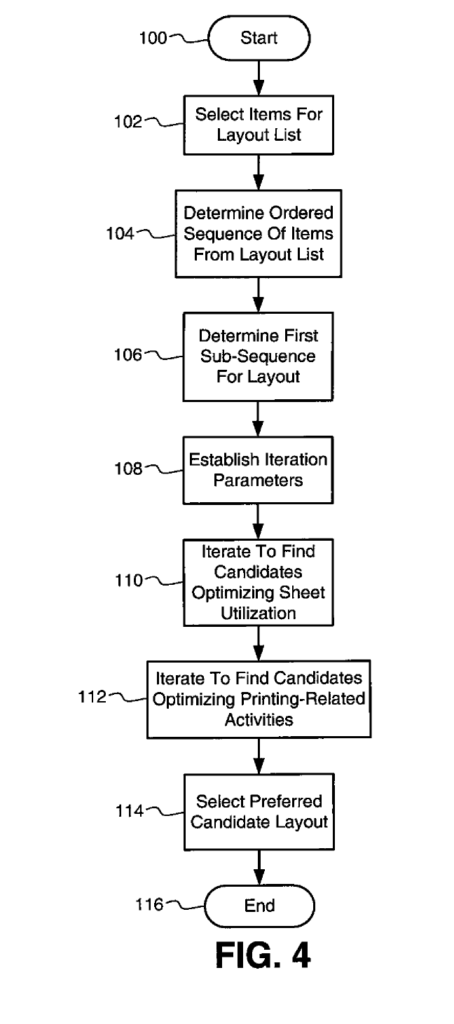

FIG. 4 is a flow chart diagram illustrating an exemplary method for identifying a layout for a list of items on a sheet according to the present invention. The method begins at block 100 and proceeds to block 102 where a layout list, comprising the list of items to be considered for layout on the sheet, can be determined. This can be done manually or automatically by selecting items from the list of pending items described above. For example, automatic selection of items can be based on the order and/or the area of the items. In one embodiment, items are selected automatically based on the pending list order and limited by their aggregate area. In particular, items are selected until their aggregate area exceeds a pre-defined limit. For example, a configurable limit near 80% of an effective sheet area increases the likelihood of a desirable candidate layout being found.

For the purposes of this application, an effective sheet area refers to a subset of the overall sheet for a layout, to account for margins, printing marks and the like. Similarly, an effective item area refers to a subset of the item area corresponding to the area of the sheet that must be reserved for the item in any layout. As an example, one may choose to allow item bleed areas to overlap in a layout. For simplicity, in the examples shown, assume that effective item and sheet areas are 100% of the area calculated from their overall dimensions.

Many alternatives for selecting items for a layout list can be envisioned. As one example, an item with a large area and small desired quantity, relative to earlier items in the pending list could be excluded from the layout list as it might adversely effect the efficiency of all layouts (e.g. item F from Table 1). As another example, an item with a relatively small area could be selectively included in the layout list even if the aggregate item area exceeds the basic limit. In practice, many printing shops tolerate a certain quantity of over-production of printed items (e.g. placing them in inventory for future orders, building goodwill, and up-selling a customer).

Regardless of the means of selecting, assume that a layout list has been identified where the aggregate item area does not exceed the sheet area limit. For example, assume the layout list includes items A-E, but not item F, from Table 1.

The method then proceeds to block 104 where an ordered sequence of items, based on the layout list, is determined. According to one preferred embodiment, the sequence of items is based on reducing a quantity of sheets required to produce the desired quantity of items from the layout list without exceeding the effective sheet area. Table 2 depicts an exemplary ordered sequence of items determined for the layout list. An aggregate item area for current and preceding items of the order is depicted and is used to calculate an upper bound for sheet utilization.

TABLE 2
Ordered Sequence of Items for 7500 Unit Layout

| | | | | Aggregate | | |
|---|---|---|---|---|---|---|
| | | | | Item | | Sheet |
| Sequence | Item | Ref. | Item | Area On | Sheet | Quantity |
| Ordinal | Id | Numeral | Area | A Sheet | Utilization | Required |
| 1 | A | 1 | 2500 | 2500 | 33.3% | 500 |
| 2 | B | 2 | 1875 | 4375 | 58.3% | 500 |
| 3 | C | 3 | 625 | 5000 | 66.7% | 1000 |
| 4 | D | 4 | 1250 | 6250 | 83.3% | 1000 |
| 5 | E | 5 | 250 | 6500 | 86.7% | 1000 |
| 6 | C | 6 | 625 | 7125 | 95.0% | 800 |
| 7 | E | 7 | 250 | 7375 | 98.3% | 500 |

One can see from Table 1 that items A and B first govern the sheet quantity to be 500. Then item C governs the sheet quantity to be 1000, resulting in a significant overage of items A and B. One can also see that adding a copy of item C (Ref. 6) causes item E to govern the sheet quantity to be 800. Adding a copy of item E (Ref. 7) causes items A, B and D (Ref. 1, 2, and 4) to govern the sheet quantity to be 500. Additional copies of these items cannot be added without the aggregate item area exceeding the effective sheet area of 7500 units. For the remainder of the description, item identifiers A-E shall refer to the finished items whereas item reference numerals shall refer to items in a layout.

In one embodiment, a configurable limit on acceptable overage (e.g. 25%) can be established for any item or on an item by item basis. If the limit is reached, the method could seek user input to determine how to proceed. For example, a user could revise the layout list or could override the overage limit.

Proceeding at block 106, the method determines a first sub-sequence of items, from the ordered sequence of items, as a starting point for evaluating candidate layouts. According to one embodiment, a pre-defined sheet utilization limit can be used to determine this sub-sequence. For example, assume a pre-defined limit of 80%. Thus, the sub-sequence of items 1-5 becomes the first sub-sequence considered for evaluating layouts.

Proceeding at block 108, the method establishes parameters that govern the iterative layout evaluation process that follows. These can be default values, automatically calculated values, user-defined values or a combination of these. Exemplary parameters include time limits and other exit criteria for various iterative phases as will be described below.

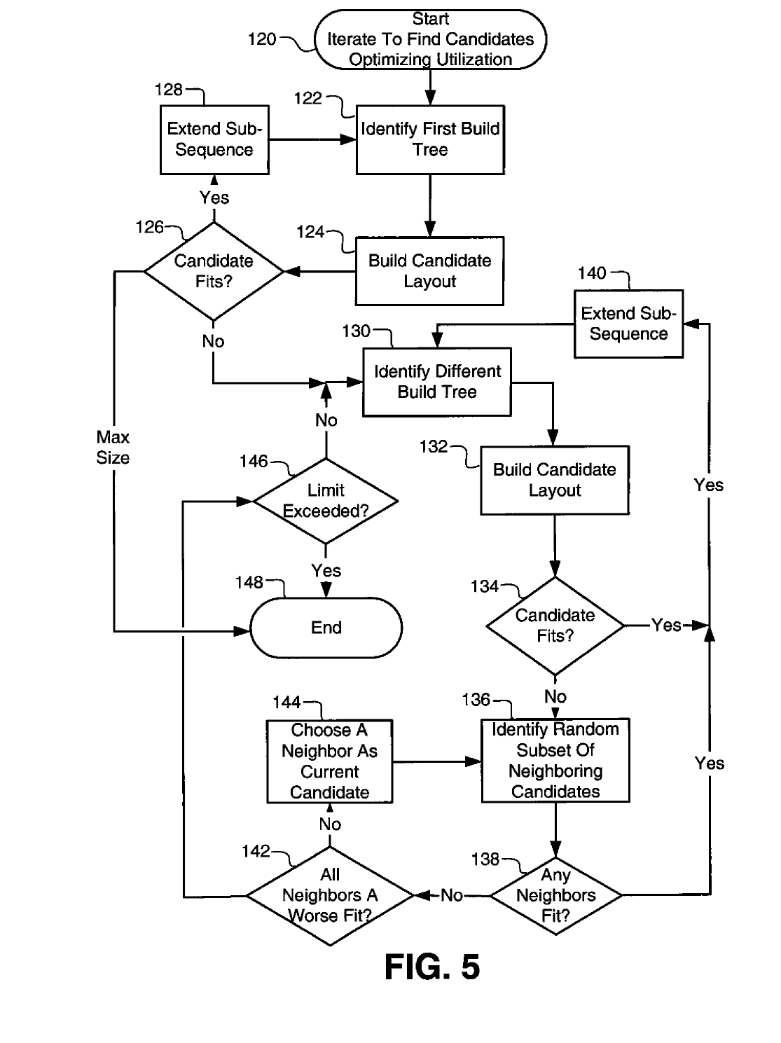

Proceeding at block 110, the method attempts to find the largest sub-sequence having at least one candidate layout that fits the sheet. Since the number of possible layout combinations for a sub-sequence can be quite large, block 110 could take a very long time to exhaustively evaluate all of the combinations. Block 110, as described in detail with reference to FIG. 5, incorporates an algorithm based on meta-items and SFs to facilitate an optimized evaluation of the range of layouts. A successful outcome from block 110 includes information about a sub-sequence, which is the same as or an extension of the first sub-sequence, with at least one candidate layout that fits the effective sheet area for the identified sub-sequence.

In some embodiments, block 110 is time limited. In one preferred embodiment, the limit is established as approximately ⅔ of the overall time limit configured for the entire method of FIG. 4. Experiments have shown that a time limit of one minute for the method of FIG. 4 produces adequate results for a variety of layout list and sheet size combinations. For example, when operating on an computer, configured with the Mac OS X (v 10.3) operating system, a 2.16 GHz Intel Core Duo CPU, and 2 GB memory, approximately thirty customer test cases, comprising sequences of twenty to fifty items having between three and seven distinct sizes, produced results in one minute that were as good as or better than the customer could create manually.

Proceeding at block 112, the method seeks to find other candidate layouts that fit the sheet for the sub-sequence identified by block 110. In particular, block 112 evaluates a selection of candidate layouts based on the cost of printing-related activities associated with the sheet. In one preferred embodiment, the cost of cutting the sheet is one basis for evaluating candidates that fit the layout. Another exemplary basis for evaluating layouts can be similar inking requirements for items within zones of the sheet, to facilitate efficient press ink-key settings. In some embodiments, block 112 is also time limited. In one preferred embodiment, the limit is configured as approximately ⅓ of the overall time limit for the entire method of FIG. 4.

Proceeding at block 114, the method selects a preferred candidate layout from amongst those identified in preceding blocks. As one option, block 114 can select the layout identified by block 112. In this case, the layout can be produced as part of an automated printing process that will automatically produce a layout of the items and print them on the sheet. As one alternative, a print operator can be presented with some or all of the candidate layouts that fit. Many options exist in this case for refinement. As an example, the operator could alter iteration parameters and restart some part of the process (e.g. search for more candidates that optimize printing-related activities). As another example, the operator could alter the layout list to include or exclude certain items and restart the process. At some point, however, having selected one candidate layout for the sheet, the method proceeds to block 116 and ends.

FIG. 5 is a flow chart diagram illustrating an exemplary method for iteratively finding candidate layouts that optimize sheet utilization according to the present invention. The method begins at block 120 with a first sub-sequence supplied as input. Proceeding at block 122, the method identifies a first build tree for the current sub-sequence.

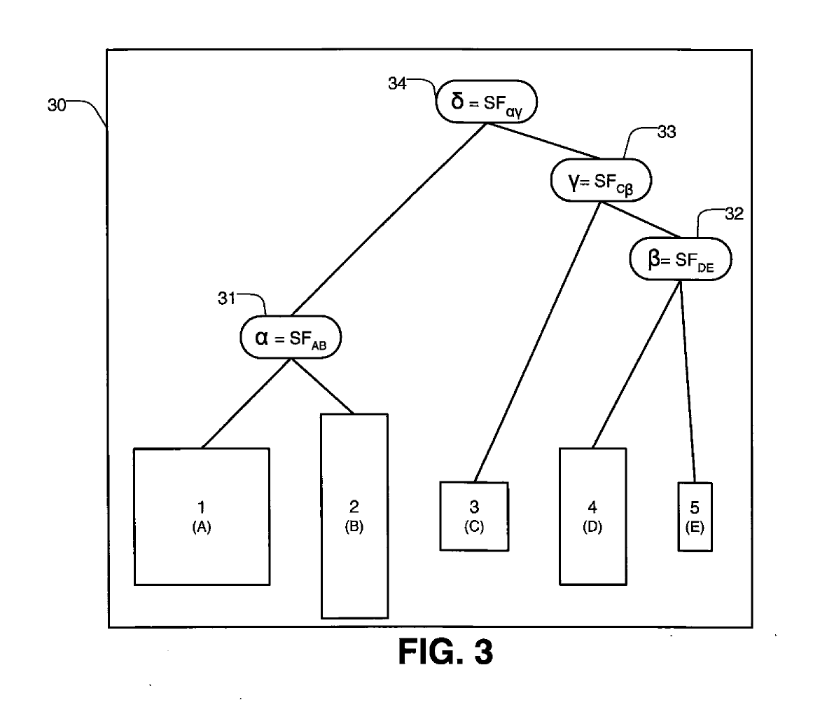

FIG. 3 is a diagram illustrating an exemplary build tree 30 according to the present invention. Exemplary build tree 30 comprises a tree of nodes with leaf nodes corresponding to the current sub-sequence of items 1-5. Parent nodes 31-34 have associated SFs based on their child nodes. For example, node 32 is the parent to child nodes corresponding to items 4-5. Parent node 33 is a higher-level parent node since it is a parent to at least one lower-level parent node. Parent node 34, as the top-most node, corresponds to the root of build tree 30. A parent node's SF can be derived from its child node SFs. As an example, the SF for a parent node can be the set of meta-items resulting from each combination of pairs of meta-items of child SFs. See the discussion below for additional details regarding SF construction.

It will be obvious to those skilled in the art that there are many different build trees 30 that can be constructed for items 1-5. In a preferred embodiment, the first build tree can be identified in a deterministic manner. In particular, SFs for the set of all possible pairings of orphaned nodes (i.e. nodes without a parent) are evaluated according to a pre-defined criteria to determine which pair should be combined to create the first parent node. Note that all of the leaf nodes of FIG. 3 are initially orphaned, as is each newly created parent node. This process is repeated until there is only one orphaned node remaining, namely the root node.

In one preferred embodiment, basis values can be computed for each candidate SF representing a pairing. In particular, minimums for overall area and wasted area basis values can be computed for each candidate SF. With reference to FIG. 2, meta-items 20A, 20C, 20E, and 20H each have the smallest overall area (i.e. SF.MinArea=3×10=30 units) and each has the minimum waste area (i.e. SF.MinWaste=30−12−12=6 units). Another basis value can be computed by combining a shape function's minimum waste, minimum area and/or other attributes.

An exemplary combined basis value (CBV) formula can be defined as:

CBV=((SFₚₐᵣₑₙₜ.MinArea—SF_{Child1}.MinArea−SF_{Child2}.MinArea)*R1)+SF_{Parent}.MinArea)

where R1 is a configurable weighting factor for waste. The CBVs for the set of candidate SFs can then be evaluated according to a criteria (e.g. minimization) to select the pairing of orphaned nodes with the desired CBV as the preferred SF for the next parent node. Note that build tree 30, as illustrated in FIG. 3, was not created with the deterministic method described above.

Proceeding at block 124, the current build tree is processed to build a candidate layout. This involves traversing the build tree from the root to select a SF value and corresponding meta-item for each parent node in order to allocate a portion of the available sheet area to each of the node's children on the basis of the meta-item's pair of constituent items. In one embodiment, where SF values are ordered by ascending width, the first SF value whose meta-item fits the currently available height can be selected. If none fit, the SF value with a meta-item that most closely fits the available area on the basis of first width and then height can be selected. It is clear that other selection criteria can be used. For example criteria based on associated meta-item attributes, such as dimension, area, waste, orientation of items, and cut orientations can be used in relation to available area attributes, such as dimensions and overall area, can be used.

Traversing parent nodes of a build tree can involve serializing the processing of child nodes. According to one embodiment, the serialization order is random. Other options exist for serialization order. For example, traversal can favor children based on lateral association (e.g. left or right), or favor based on the child node level (e.g. depth first or last) or some combination of these and/or other criteria. A candidate layout is complete when each leaf node has been placed according to a potion of available sheet area allocated to it by traversing a parent node.

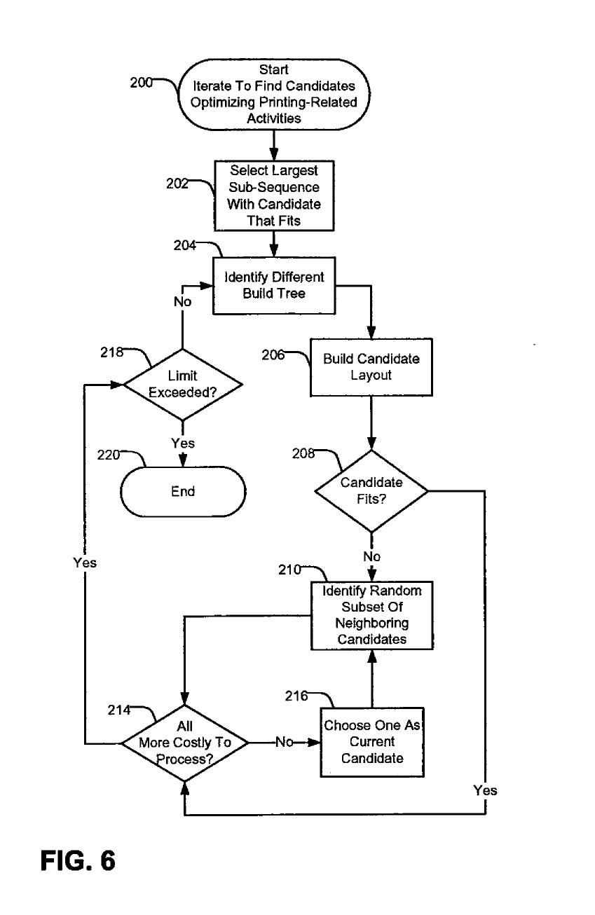

Proceeding at block 126 the method decides whether the candidate layout fits the sheet. If it does, the method proceeds to block 128 where the sub-sequence is incremented within the limits of the ordered sequence of items. If the candidate layout does not fit, the method proceeds to block 130. Otherwise, if the sub-sequence is of a maximum size, the method proceeds to block 148 and ends. Throughout, the description of FIGS. 5 and 6, when a candidate layout is identified as fitting the sheet, the candidate layout is saved for later consideration.

At block 130, the next phase of the process begins wherein the method introduces some randomness into the search for the largest candidate layout that fits the sheet. According to one embodiment, block 130 identifies different build trees by introducing some randomness into the previously deterministic method. In particular, the method chooses a pair of orphaned nodes for a parent node by selecting randomly from amongst a subset of the candidate SFs with preferred basis values. For example, select one build tree from amongst ten of the complete set SFs with the best basis value. In some embodiments, the subset is identified as a configurable ratio (R2) of the population of candidate SFs.

Proceeding at block 132, the method builds a candidate layout in a manner consistent with the description for block 124. Proceeding at block 134, the method decides whether the new candidate layout fits the sheet. If it does fit, the method proceeds to block 140 where the sub-sequence is extended within the limits of the ordered sequence of items. If the sub-sequence cannot be extended, the method can proceed to block 130 to identify another potential candidate for the current sub-sequence. Alternatively, and if the candidate layout does not fit the sheet, the method proceeds to block 136.

Proceeding at block 136, the method identifies a subset of neighbors for the current candidate layout. According to a preferred embodiment, neighbors are identified by swapping pairs of nodes in the build tree corresponding to the current candidate layout. As an example, and with reference to FIG. 3, leaf nodes for items 1 and 3 can be swapped. As another example, parent node 31 and the leaf node for item 3 can be swapped. This results in item 3 being a child of node 34 and node 31 being a child of node 33. In one embodiment, a parent node cannot be swapped with a descendent. In some embodiments, parent nodes can be swapped with descendants after a fashion. As an example, node 33 can replace one of items 4 and 5 as a child of node 32 and the replaced item (e.g. item 4) can then become the second child of node 33. Node 32 then replaces node 33 as a child of node 34.

In one embodiment, the subset of neighbors can be identified as a configurable ratio (R3) of the range of possible neighbors (e.g. the set of all possible node swaps) using a randomized selection method. For each neighboring build tree, block 136 builds a corresponding candidate layout consistent with the description of block 124 above. In one preferred embodiment, the randomized selection occurs from amongst a configurable ratio (R4) of the best neighboring build trees amongst the R3 subset of neighboring build trees, based on a SF basis value for each neighboring build tree.

Proceeding at block 138, the method evaluates whether any of the subset of neighboring candidate layouts, corresponding to selected neighboring build trees, fit the sheet. If any do, the method proceeds to block 140, described above. If none of the neighboring candidate layouts fit the sheet, the method proceeds to block 142 whether all of the neighboring candidate layouts are a worse fit for the sheet than the current candidate used to determine the neighbors.

If any neighboring candidate is as good or a better fit than the current candidate, the method proceeds to block 144 where one of the neighboring candidates is selected as the new current candidate. In one preferred embodiment, the selection is a randomized selection. The method then proceeds back to block 136 to continue searching for a candidate that either fits the sheet or more closely fits the sheet.

A useful analogy for this process is hill climbing in the dark where one is attempting to find the highest peak (i.e. the largest sub-sequence whose candidate fits the sheet) but in the process one may find local peaks (e.g. a smaller sub-sequence that fits). Searching for peaks may involve progressing in randomized directions from a current prostitution where progress is sustained if it is up-hill or lateral (e.g. potentially leading to an up-hill gradient). Although not shown in FIG. 5, some neighboring candidate layout search limits can be established in some embodiments. For example, a configurable limit can be established on the number of iterations while moving laterally amongst neighbors. As another example, a configurable limit can be established for the number of iterations of moving up-hill without reaching a new peak.

If all of the neighboring candidate layouts, determined at block 142, are a worse fit than the current candidate, the method proceeds to block 146 where the method determines whether a configurable limit on the number of iterations of randomized build tree selection has been reached. If the limit has been reached, the method proceeds to block 148 where it ends. Otherwise the method proceeds to block 130 to identify a new build tree for the current sub-sequence.

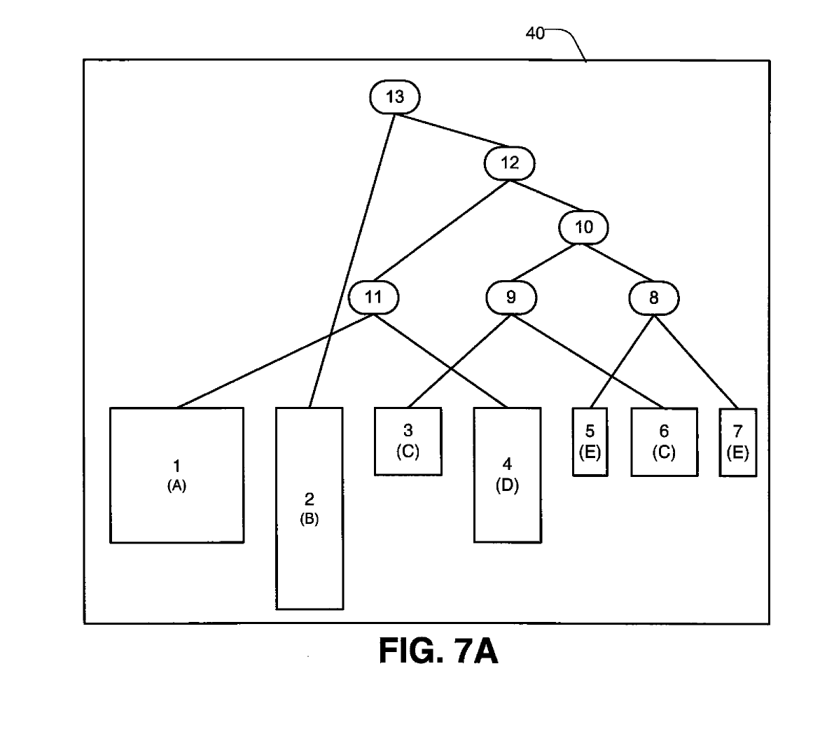

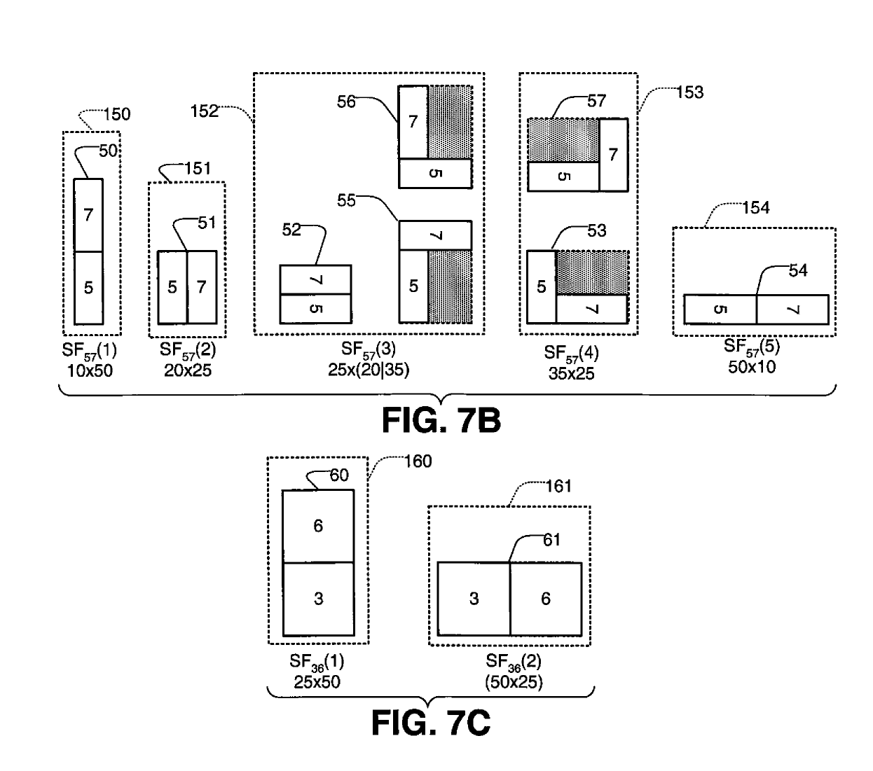

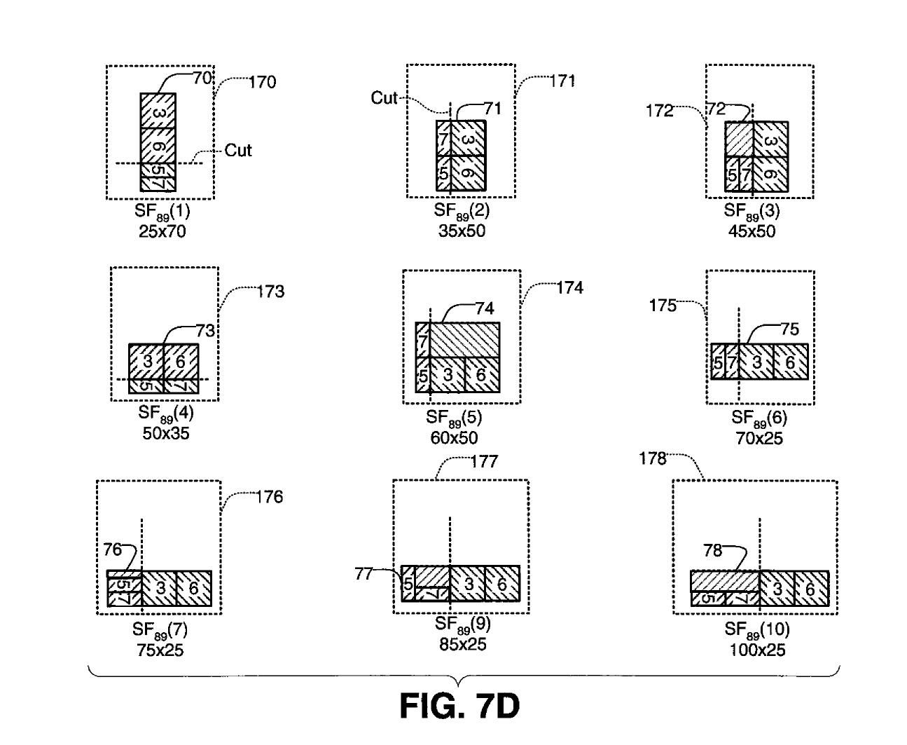

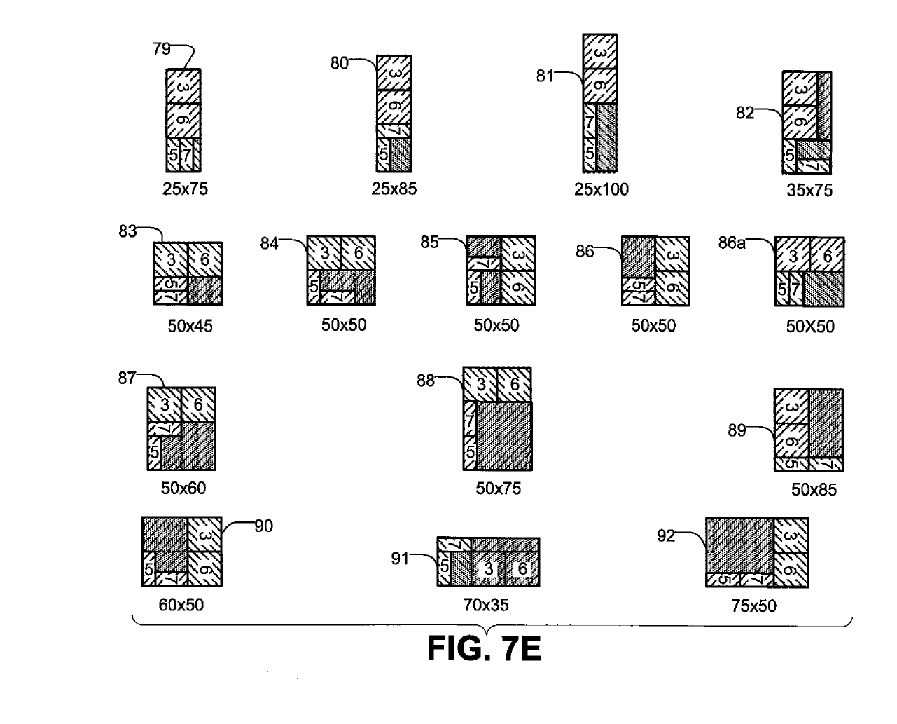

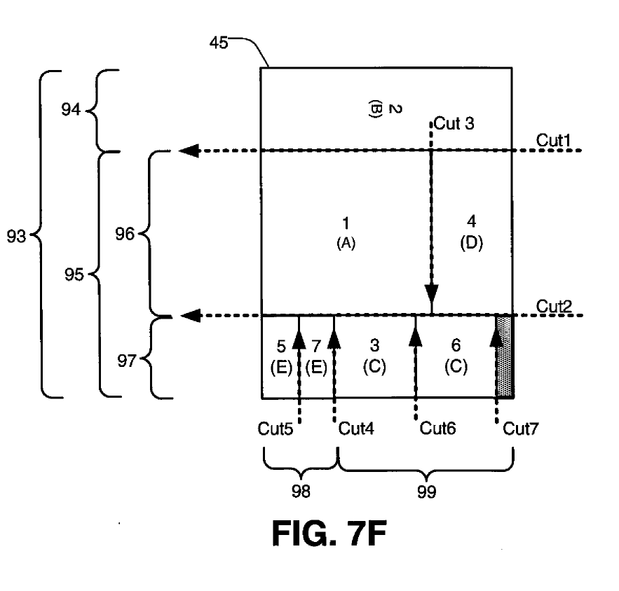

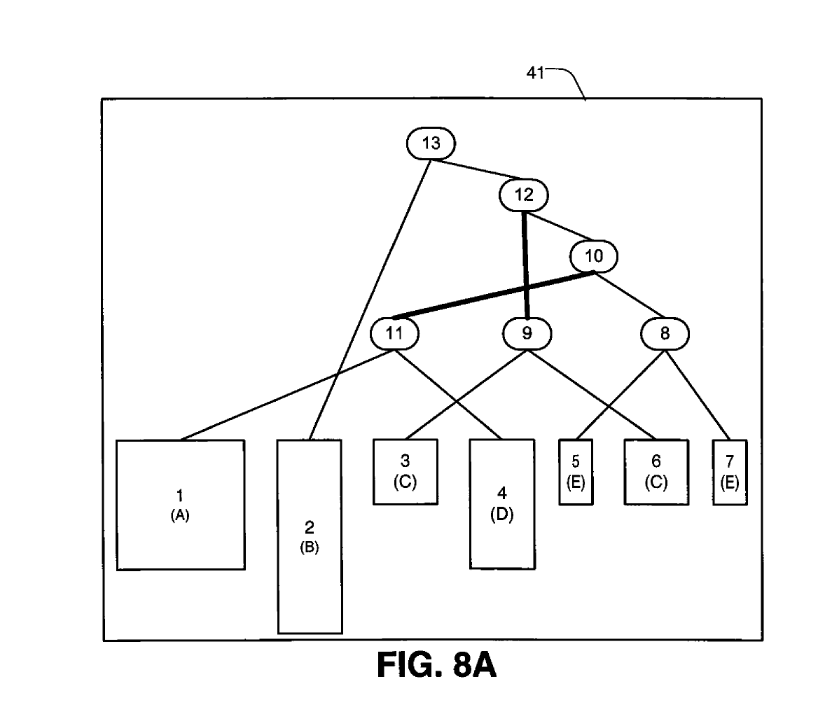

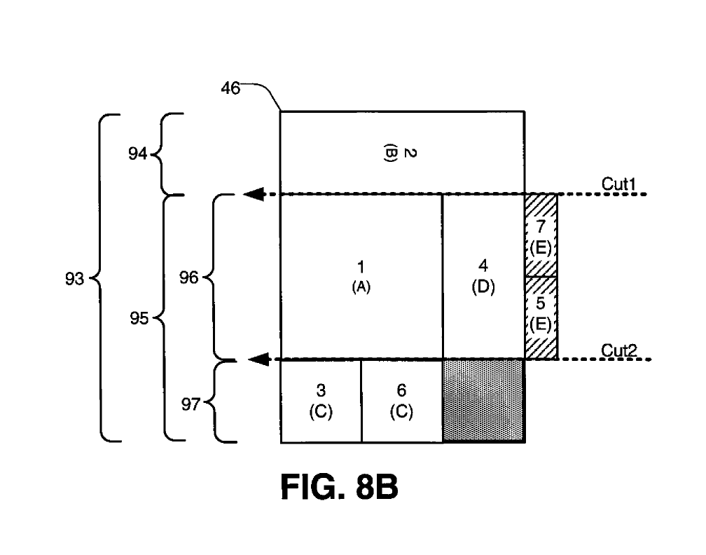

FIGS. 7A-7E and 8A-8B provide the basis for a more detailed description of several aspects introduced above. FIG. 7A is a diagram illustrating a build tree 40 for a candidate layout identified by the method of FIG. 5. Build tree 40 corresponds to a sub-sequence corresponding to the ordered sequence of items 1-7 and parent nodes 8-13. A non-pictorial representation of the build tree 40 of FIG. 7A is as follows:

Build Tree=[(5,7); (3,6); (8,9); (1,4); (10,11); (2,12)].

This representation depicts an ordered list of parent node definitions corresponding to the order of parent node reference numerals (e.g. node 8=(5,7)).

FIG. 7B is a diagram illustrating an exemplary SF for parent node 8 of build tree 40. Meta-items 50-57 are depicted in relation to SF values 150-154. In particular, meta-items based on pairing items with normal and one 90° rotation and adjacent-right and adjacent-above positions have been considered. SF values 150-154 are associated respectively with meta-items 50-54 based on ascending width order and some exclusion criteria. For example, SF₅₇(3) 152 is associated with meta-item 52 because meta-items 52, 55 and 56 have a common width. Meta-item 52 is selected because it has the smallest height amongst the group with common width (e.g. least waste as indicated by shaded areas of items 55-56). In other words, meta-items 55-56 are inferior meta-items and are excluded from the SF.

FIG. 7C is a diagram illustrating an exemplary SF corresponding to parent node 9. SF values 160-161 correspond respectively to meta-items 60-61. In one embodiment, meta-items corresponding to rotations of items 3 and 6 are excluded and thus are not associated with SF values. In other embodiments, where item rotation may be relevant, it could be prudent to include them and associate them with distinct SF values.

FIG. 7D is a diagram illustrating an exemplary SF for parent node 10 which has parent nodes 8 and 9 as children. SF values 170-178 have corresponding meta-items 70-78 respectively. Meta-items 70-78 are depicted with their boundaries (thick solid line) and their cuts (dashed line). Note that each meta-item depicts two rectangular constituent items on either side of the cut and shaded distinctly with left and right diagonal lines. Each constituent item is depicted as partly transparent to show the relationship with exemplary SF values for child nodes 8 and 9. For example, meta-item 70 includes a constituent item above the cut with an available area with dimensions 25×50. SF value 160 (e.g. items 3 and 6) is shown in relation to the constituent meta-item as one that fits exactly. However, SF values 150-152 can also fit within the available area of this constituent item.

FIG. 7E is a diagram illustrating excluded meta-items 79-92 for node 10 in a manner similar to FIG. 7D. Excluded meta-items 79-92 can be derived from meta-items 50-57 and 60-61 associated with SF values of nodes 8-9. They are inferior to those of FIG. 7D since they are less efficient. As an example, meta-items 79-81 are inferior to meta-item 70 because they have the same width but are taller and have more wasted area. As another example, meta-items 82-87 are inferior to meta item 73.

In another preferred embodiment, SF values 172, 176, 177 and 178 can also be excluded because their corresponding meta-items are wider but not shorter than a previously identified SF value. For example, meta-item 72 is the same height as meta-item 71. Also, meta-items 76-78 are the same height as meta-item 75.

FIG. 7F is a diagram illustrating an exemplary candidate layout 45 derived for build tree 40 of FIG. 7A according to the present invention. An example of block 124 is now presented with respect to the examples of FIGS. 7A-7F. For this example method, serialization of child nodes is randomized and SF value selection favors meta-items that most closely fit first available width and then available height.

Traversing node 13 of build tree 40 requires first selecting a SF value. Based on the SF value selection criteria, assume that a meta-item 93, with dimensions 75×100, is associated with the selected SF value for node 13. Although the SF values for node 13 are not shown, it should be clear that meta-item 93 is amongst those that are candidate values. Meta-item 93 includes Cut1 (dashed arrow) which identifies constituent items 94 and 95 with respective dimensions of 75×25 and 75×75. Leaf node 2 is then selected as the child node associated with consistent item 94. Rotated item 2 exactly fits both the available width and height of consistent item 94 and so it is placed in layout 45 as depicted. Similarly, child node 12 is selected for association with constituent item 95.

In one preferred embodiment, selection of a child node for association with a constituent item is based on the minimum area of the child node. For a leaf node, the minimum area corresponds to the item area. For a parent node, the minimum area corresponds to the SF.MinArea calculated attribute. One of the pair of child nodes can be selected in a random fashion, for example, to be compared with the area of a first constituent item. If the minimum area of the selected child node is less than the available area, the association is made. Otherwise, the other node is selected for association if it fits or more closely fits. In the example of node 13, it is clear that only the node corresponding to item 2 has a minimum area that fits the area of constituent item 94.

Traversing node 12 also requires first selecting a SF value. Based on the value selection criteria, assume that the meta-item associated with the selected SF value for node 12 has dimensions corresponding to the area of constituent item 95. Further assume that the selected meta-item includes Cut2 which identifies constituent items 96 and 97 with respective dimensions of 75×50 and 75×25. Parent node 11 is then identified as the child node associated with consistent item 96. Similarly, parent node 10 is selected as the child node associated with consistent item 97.

Traversing node 11 also requires first selecting a SF value. Assume that a meta-item, with Cut3 and based on items 1 and 4, is associated with the SF value selected for node 11. Since the dimensions of the associated meta-item fit the area of constituent item 96 exactly, items 1 and 4 are placed as depicted.

Traversing node 10 also requires first selecting a SF value. From FIG. 7D it is known that SF value 175 has associated meta-item 75 with dimensions of 70×25 which includes a cut identifying consistent items with dimensions of 20×25 and 50×25. Similarly, SF value 176 has associated meta-item 76 with dimensions of 75×25 which includes a cut identifying constituent items with dimensions of 25×25 and 50×25. Based on the selection criteria, SF value 175 is selected resulting in a meta item including Cut4 which identifies constituent items 98 and 99 having respective dimensions of 20×25 and 50×25. Next, parent node 8 is identified as the child node associated with constituent item 98. Similarly, child node 9 is associated with constituent item 99.

Traversing node 8 first involves selecting SF value 151, whose meta-item 51 has dimensions 20×25. Note that meta-item 52 also fits but was not preferred. This results in constituent items for meta-item 51 being placed as depicted with Cut5 corresponding to the cut defined by meta-item 51. As described above, association of item 5 with the constituent item on the left side of Cut5 can be subject to some randomness given that nodes for items 5 and 7 have the same minimum area.

Traversing node 9 first involves selecting SF value 161 and resulting in placement of items 3 and 6 as depicted with Cut6 corresponding to the cut defined by meta-item 61 and Cut7 implied by the difference in dimensions between meta-item 61 and constituent item 99.

Build tree 40 may have been identified as part of the process of searching for neighboring candidate layouts (e.g. block 136). FIG. 8A illustrates a build tree 41, which may have been a current build tree from which build tree 40 was identified as a neighbor. Build tree 41 is the same as build tree 40 except that parent nodes 9 and 11 are swapped.

FIG. 8B is a diagram illustrating and exemplary candidate layout 46 created on the basis of build tree 41. Clearly, traversing node 13 was equivalent for both build trees 40 and 41. Further, in traversing node 12, the same meta-item with constituent meta-items 96 and 97 was selected. However, the randomized selection of child nodes picked the right-hand node this time (i.e. node 10) for association with constituent item 96.

Traversing node 10 this time yielded a meta-item that almost fits the area of constituent item 96. Items 5 and 7 extend beyond the sheet boundary.

Traversing node 9 this time is based on an available are of 75×25, corresponding to constituent item 97 and thus items 3 and 6 are placed as depicted. Clearly, candidate layout 46 is inferior, fit-wise, when compared with neighboring candidate layout 45.

Having found at least one candidate layout that fits the sheet the next optimization is described by FIG. 6, which is a flow chart diagram illustrating an exemplary method for iteratively finding candidate layouts that optimize printing-related activities according to the present invention. The method begins at block 200 and proceeds to block 202 where the largest sub-sequence identified from the method of FIG. 5 is selected.

Proceeding at block 204, the method identifies a build tree in a randomized fashion similar to that described above for FIG. 5. In one embodiment, the subset for randomized selection is based upon a different SF basis value determined for the build tree.

The method then proceeds to build a candidate layout at block 206 in a fashion similar to that described above for FIG. 5. Proceeding at block 208, the method first decides whether the candidate layout fits the sheet. If it does, the method proceeds to block 214, described below. If the layout does not fit, the method proceeds to block 210 where a randomized subset of neighboring candidates is identified in a fashion similar to that described above (e.g. swapping nodes).

Proceeding at block 214, the method determines whether all of the one or more of the neighboring candidate layouts are more costly to process than the current candidate layout. According to one embodiment, a plurality of cost factors is considered. One is fit to the sheet so that a neighbor that fits better than the current candidate can replace the current candidate. Other exemplary cost factors are described below. If one or more of the new candidate layouts are less costly to process, the method proceeds to block 216. If all are more costly to process, the method proceeds to block 218.

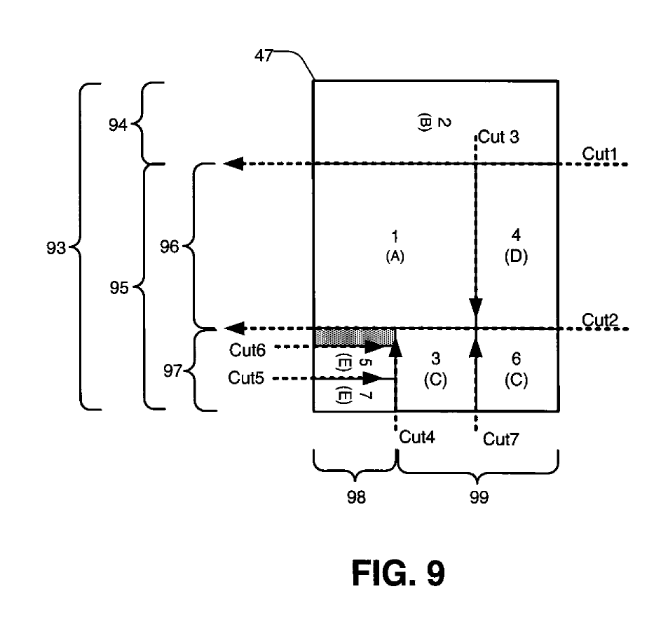

FIG. 9 is a diagram illustrating an exemplary candidate layout 47 that is more costly to process than candidate layout 47 of FIG. 7F. One can envision a variation on the previous discussion where, during traversal of node 10, selection of SF value 176 was selected instead of SF value 175 (see above). For example, criteria could allow a randomized selection from amongst the meta-items that fit within a certain tolerance of the available area. As another example, favoring selection of SF value 175, the method may be optimized by keeping track of cut orientations associated with nodes that have already been traversed, and augmenting SF value selection criteria with a consistency of cut-orientation criterion.

According to one embodiment of the present invention, a cost-function that models the cost of all printing-related activities can be developed. In a simple model, cutting and sheet rotating activities in a post-press environment can be used in determining the lower-cost layout. For example, in one embodiment, the cost of rotating a sheet or portion of a sheet is assigned a default value of 10 times the cost of performing a cut. In a more complex model, activities such as setting ink keys and binding activities can also be modeled and incorporated in a total cost function. Proceeding at block 216, the method saves each lower-cost candidate and selects one as the current candidate layout and then proceeds to block 210 to identify additional neighboring candidate layouts.

Proceeding at block 218, the method decides whether a configurable limit on the number of iterations of randomized build tree selection has been reached. If the limit has been reached, the method proceeds to block 220 where it ends. Otherwise the method proceeds to block 204 to identify another build tree for the current sub-sequence. As describe above for FIG. 5, similar configurable limits on neighboring candidate searches can be established.

In some embodiments, a computer system performs the method of FIG. 4. As an example, an imposition software program can perform the method. As another example, a printing workflow system can include an imposition software module as part of an automated or semi-automated job processing module that accepts pending jobs as input and produces layouts for a printing session as output.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### Parts List

1 item
2 item
3 item
4 item
5 item
6 item
7 item
8 node
9 node
10 node
11 node
12 node
13 node
20 meta-item
20A meta-item
20B meta-item
20C meta-item
20D meta-item
20E meta-item
20F meta-item
20G meta-item
20H meta-item
21 meta-item width
22 meta-item height
23 meta-item waste
24 meta-item cut
25 shape function (SF)
30 build tree
31 parent node
32 parent node
33 parent node
34 parent node
40 build tree
41 build tree
45 candidate layout
46 candidate layout
47 candidate layout
50 meta-item
51 meta-item
52 meta-item
53 meta-item
54 meta-item
55 meta-item
56 meta-item
57 meta-item
60 meta-item
61 meta-item
70 meta-item
71 meta-item
72 meta-item
73 meta-item
74 meta-item
75 meta-item
76 meta-item
77 meta-item
78 meta-item
79 meta-item
80 meta-item
81 meta-item
82 meta-item
83 meta-item
84 meta-item
85 meta-item
86 meta-item
87 meta-item
88 meta-item
89 meta-item
90 meta-item
91 meta-item
92 meta-item
93 meta-item
94 constituent item
95 constituent item
96 constituent item
97 constituent item
98 constituent item
99 constituent item
100 method block
102 method block
104 method block
106 method block
108 method block
110 method block
112 method block
114 method block
116 method block
120 method block
122 method block
124 method block
126 method block
128 method block
130 method block
132 method block
134 method block
136 method block
138 method block
140 method block
142 method block
244 method block
146 method block
148 method block
150 SF value
151 SF value
152 SF value
153 SF value
154 SF value
160 SF value
161 SF value
170 SF value
171 SF value
172 SF value
173 SF value
174 SF value
175 SF value
176 SF value
177 SF value
178 SF value
200 method block
202 method block
204 method block
206 method block
208 method block
210 method block
214 method block
216 method block
218 method block
220 method block

1. A method for determining a layout of items on a sheet, the method comprising:
identifying dimensions of the sheet;
identifying a plurality of items for placement in the layout based on the dimensions of the sheet wherein an item comprises item dimensions and a desired item quantity;
determining an ordered sequence of items based on the plurality of items as candidates for placement in the layout wherein the sequence is selected to reduce a sheet quantity required to produce the desired item quantities;
determining a first sub-sequence of the ordered sequence of items as a starting point for producing the layout;
producing a first candidate layout based on the first sub-sequence of items;
performing an iterative process to identify additional candidate layouts that fit the sheet for a same-sized or larger sub-sequence wherein the iterative process is designed to evaluate a subset of possible candidate layouts; and
selecting a preferred candidate layout as the layout.

2. A method according to claim 1 wherein determining the ordered sequence of items comprises:
(a) calculating an area for each item of the plurality of items and the sheet based on their respective dimensions;
(b) adding a first copy of each item to the ordered sequence of items wherein the aggregate area of the sequence of items is less than the sheet area;
(c) determining a sheet quantity based on the desired quantity for each unique item and the number of copies of each unique item in the ordered sequence of items; and
(d) adding another copy of an item governing the sheet quantity to the ordered sequence of items to reduce the sheet quantity wherein the aggregate area of the sequence of items is less than the sheet area.

3. A method according to claim 1 wherein producing a candidate layout based on a sub-sequence of items comprises:
identifying a build tree based on the sub-sequence of items; and
traversing the build tree to build the candidate layout.

4. A method according to claim 3 wherein identifying the build tree based on the sub-sequence of items comprises:
(a) selecting each item of the sub-sequence of items as orphaned leaf nodes for the build tree;
(b) creating a new parent node by selecting a pair of orphaned nodes as child nodes for the new parent node;
(c) creating a shape function representing a plurality of meta-items based on the pair of child nodes;
(d) associating the shape function with the new parent node; and
(e) repeating steps (b) to (d) until only one orphaned node remains as the root node.

5. A method according to claim 4 wherein a meta-item comprises arrangement information describing an arrangement of first and second objects, boundary information for the arrangement, and cutting information for cutting the boundary to produce the objects, and wherein the first object comprises a first item or meta-item, derived from one of the child nodes, and wherein the second object comprises a second item or meta-item, derived from the other one of the child nodes.

6. A method according to claim 5 wherein arrangement information comprises position information and rotation information.

7. A method according to claim 5 wherein traversing the build tree to build the candidate layout comprises:
(a) allocating an area of the sheet as an area for the root node;
(b) selecting the root node of the tree as the current parent node;
(c) selecting a shape function value associated with the current parent node wherein the value corresponds to one meta-item of the plurality of meta-items;
(d) dividing the area for the current parent node into first and second areas based on the cutting information of the selected meta-item;
(e) allocating the first area as an area for one of the child nodes associated with the current parent node;
(f) allocating the second area as an area for the other one of the child nodes associated with the current parent node;
(g) placing an item in the candidate layout based on the area allocated to the child node and the dimensions of the item associated with the child node wherein the child node comprises a leaf node; and
(h) repeating steps (c) to (h) with each child node selected as the current parent node wherein the child node comprises a parent node.

8. A method according to claim 1 wherein performing the iterative process to identify additional candidate layouts that fit the sheet for a same-sized or larger sub-sequence comprises:
performing a first process including a plurality of iterations wherein an iteration comprises building a candidate layout for the current sub-sequence using deterministic building criteria whereupon building a candidate layout that fits the sheet for an iteration, building also includes extending the current sub-sequence for the next iteration; and
performing a second process including a plurality of iterations wherein an iteration comprises building at least one candidate layout for the current sub-sequence using randomized building criteria whereupon building a candidate that fits the sheet for an iteration, building also includes extending the sub-sequence.

9. A method according to claim 8 wherein building at least one candidate layout for the current sub-sequence comprises:
selecting a candidate layout that does not fit the sheet as the current candidate layout;
building neighboring candidate layouts based on the current candidate layout; and
selecting a neighboring candidate layout as the current candidate layout wherein the neighboring candidate is a better fit.

10. A method according to claim 8 wherein performing an iterative process to identify additional candidate layouts that fit the sheet for a same-sized or larger sub-sequence also comprises:
performing a third process including a plurality of iterations wherein an iteration comprises building at least one candidate layout for the largest sub-sequence identified in the first and second processes; and
wherein building includes evaluating the at least one candidate layout based on the cost of printing-related activities for a sheet based on the candidate layout.

11. A method according to claim 10 wherein evaluating the at least one candidate layout based on the cost of printing-related activities comprises evaluating on the basis of a cost of cutting the sheet.

12. A method according to claim 10 wherein building at least one candidate layout for the largest sub-sequence identified in the first and second processes comprises:
selecting a candidate layout as the current candidate layout wherein selecting is based on the cost of printing-related activities for the sheet based on the candidate layout;
building neighboring candidate layouts based on the current candidate layout; and
selecting a neighboring candidate layout as the current candidate layout wherein the neighboring candidate has a lower cost of printing-related activities.

13. A method according to claim wherein performing an iterative process to identify additional candidate layouts that fit the sheet for a same-sized or larger sub-sequence comprises a time-limited process.

14. An imposition system for determining a layout of items on a sheet, the system operative to:
identify dimensions of the sheet;
identify a plurality of items for placement in the layout based on the dimensions of the sheet wherein an item comprises item dimensions and a desired item quantity;
determine an ordered sequence of items based on the plurality of items as candidates for placement in the layout wherein the sequence is selected to reduce a sheet quantity required to produce the desired item quantities;
determine a first sub-sequence of the ordered sequence of items as a starting point for producing the layout;
produce a first candidate layout based on the first sub-sequence of items;
perform an iterative process to find larger sub-sequences and produce corresponding candidate layouts that fit the sheet wherein the iterative process is designed to evaluate a subset of possible candidate layouts; and
select a preferred candidate layout as the layout.

15. A medium carrying a set of computer-readable signals comprising instructions which, when executed by a data processor, cause the data processor to execute a method according to claim 1.

16. A method for determining a layout of printing items on a printing sheet, the method comprising:
identifying dimensions of the printing sheet;
identifying a plurality of printing items for placement in the layout based on the dimensions of the printing sheet wherein a printing item is associated with printing item dimensions and a desired printing item quantity;
determining an ordered sequence of printing items based on the plurality of printing items as candidates for placement in the layout wherein the sequence is selected to reduce a printing sheet quantity required to produce the desired printing item quantities;
determining a first sub-sequence of the ordered sequence of printing items as a starting point for producing the layout;
producing a first candidate layout based on the first sub-sequence of printing items;
performing an iterative process to identify additional candidate layouts that fit the printing sheet for a same-sized or larger sub-sequence wherein the iterative process is designed to evaluate a subset of possible candidate layouts on the basis of printing sheet utilization and the cost of cutting the printing sheet; and
selecting a preferred candidate layout as the layout.
